(19) United States
(12) Patent Application Publication
(10) Pub. No.: US 2007/0079032 A1
(43) Pub. Date: Apr. 5, 2007

(54) Serial signal ordering in serial general purpose input output (SGPIO)

(75) Inventors: Sailesh Bissessur, Phoenix, AZ (US); Joseph Murray, Scottsdale, AZ (US); Brian J. Skerry, Tempe, AZ (US); Robert L. Sheffield JR., Chandler, AZ (US); Richard C. Beckett, Phoenix, AZ (US); Gregory W. Tse, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/241,161

(22) Filed: Sep. 30, 2005

(51) Int. Cl. G06F 13/38

(52) U.S. Cl. 710/71

(57) ABSTRACT

An apparatus may include a Serial General Purpose Input Output (SGPIO) initiator device. The SGPIO initiator device may have terminals to receive parallel input signals. The device may also have parallel-to-serial conversion logic to convert the parallel input signals to a serial stream. The device may further have signal ordering logic. The signal ordering logic may be in communication with the terminals and may be in communication with the parallel-to-serial conversion logic. The signal ordering logic may determine an order in which the parallel input signals are provided in the serial stream. Methods of ordering signals within an SGPIO initiator device and systems having SGPIO initiator devices are also disclosed.

### BACKGROUND

1. Field

Embodiments of the invention relate to computer system architectures. In particular, embodiments of the invention relate to Serial General Purpose Input Output (SGPIO) architectures.

2. Background Information

Serial General Purpose Input Output (SGPIO) architectures are known in the arts. In SGPIO architectures general-purpose input and/or output (I/O) signals may be serialized for transmission on a serial bus.

The I/O signals may be serialized and transmitted on the bus in a fixed order. In some cases, the order may be fixed by hardwiring. The hardwiring used to fix the order in which the I/O signals are serialized and transmitted on the transmit-side of the SGPIO architecture may be based, at least in part, on the hardwiring used to receive and route the I/O signals on the receive-side of the SGPIO architecture.

Customizing or otherwise basing the hardwiring on the transmit side of the SGPIO architecture on the hardwiring on the receive-side of the SGPIO architecture may tend to complicate routing of signals on the transmit side and/or increase the cost of providing the transmit side. Further, this may tend to promote non-optimal hardwiring on the transmit-side of the SGPIO architecture, such as, for example, signal crossings that may degrade signal integrity.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of a Serial General Purpose Input Output (SGPIO) architecture.

FIG. 2 is a block diagram of an SGPIO architecture including an SGPIO initiator device that has signal ordering logic, according to one or more embodiments of the invention.

FIG. 3 is a block diagram showing an SGPIO initiator device that has signal ordering logic implemented in a storage architecture, according to one or more embodiments of the invention.

FIG. 4 is a block diagram showing a storage architecture similar to the storage architecture shown in FIG. 3 but without the signal ordering logic.

FIG. 5 is a block diagram showing a storage architecture including a computer system that is suitable for implementing one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order to avoid obscuring the understanding of this description.

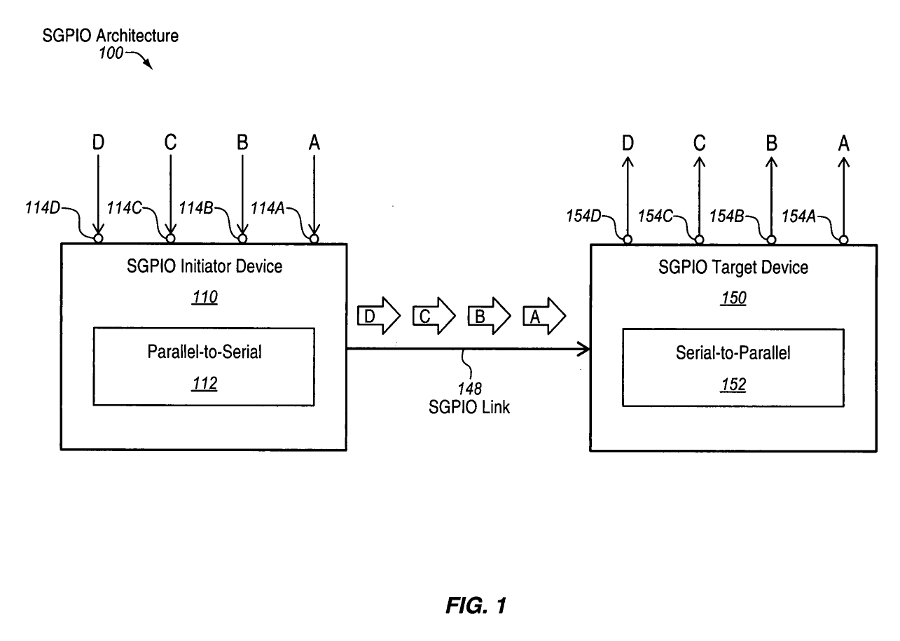

FIG. 1 is a block diagram of a Serial General Purpose Input Output (SGPIO) architecture 100. In one or more embodiments of the invention, the SGPIO architecture may be based, at least in part, on the SFF-8485 Specification for Serial GPIO (SGPIO) Bus, Revision 0.5, published 3 February 2005, published by the SFF Committee, or a subsequent specification, although the scope of the invention is not so limited. The SGPIO architecture includes an SGPIO initiator device, 110 and an SGPIO target device 150. The SGPIO initiator device and the SGPIO target device are coupled with, or otherwise in communication with, one another through an SGPIO link 148, such as, for example, a four-bit serial bus.

The SGPIO initiator device may receive a plurality of parallel input signals. For example, as shown, the SGPIO initiator device may receive the parallel input signals A, B, C, and D. The SGPIO initiator device may include a corresponding number of pins or other terminals 114A-D to receive the parallel input signals. For example, the illustrated SGPIO initiator device has a first terminal 114A to receive input signal A, a second terminal 114B to receive input signal B, a third terminal 114C to receive input signal C, and a fourth terminal 114D to receive input signal D. By way of example, the parallel input signals may include electrical signals that are applied in parallel on the terminals.

The SGPIO initiator device may generate a serial stream of signals based, at least in part, on the parallel input signals. The illustrated SGPIO initiator device includes parallel-to-serial conversion logic 112 that is coupled with, or otherwise in communication with, the terminals. The parallel-to-serial conversion logic may convert the parallel input signals to a serial stream, or may otherwise generate a serial stream based, at least in part, on the parallel input signals. The serial stream may include a plurality of serialized signals. Each of the serialized signals may correspond to one of the parallel input signals. The parallel input signals may have an order or sequence in the serialized stream.

The SGPIO initiator device may transmit or otherwise provide the serial stream to the SGPIO link. For example, as shown, the SGPIO initiator device may provide a serialized stream in which serial signal A may be provided first, a serial signal B may be provided second, a serial signal C may be provided third, and a serial signal D may be provided fourth.

The SGPIO target device may be coupled with, or otherwise in communication, with an opposite end of the SGPIO link, on a receive-side of the SGPIO architecture. The SGPIO target device may receive the serial stream. For example, as shown, the SGPIO target device may receive A first, B second, C third, D fourth.

The SGPIO target device may generate a plurality of parallel output signals based, at least in part, on the serial stream. The illustrated SGPIO target device includes serial-to-parallel conversion logic 152. The serial-to-parallel conversion logic may convert the serial stream to a plurality of parallel output signals, or may otherwise generate a plurality of parallel output signals based, at least in part, on the serial stream. The SGPIO target device may then transmit or otherwise provide the parallel output signals to another component. For example, as shown, the SGPIO target device may provide the parallel output signals A, B, C, and D over a corresponding number of pins or other terminals 152A-D. For example, as shown, the SGPIO target device has a first terminal 152A to provide signal A, a second terminal 152B to provide signal B, a third terminal 152C to provide signal C, and a fourth terminal 152D to provide signal D.

Now, the reception side of the SGPIO architecture, in particular the SGPIO target device, may assign and route the chronologically received signals of the serial stream in a hardwired or otherwise predetermined manner. In particular, as shown, the first chronologically received signal, which in this case happens to be signal A, has been routed to terminal 154A, the second chronologically received signal, which in this case happens to be signal B, has been routed to terminal 154B, and so forth. In some cases, the assignments and routings are hardwired to provide clean signal routing, with few or no signal crossings, since signal crossings may tend to degrade signal integrity.

Sometimes, the SGPIO target device and a system in which the SGPIO target device is employed, such as, for example, the disk array, may already have been designed. Further, the design may fix the assignments and routings of the signals of the serial stream to particular destinations. In such an aspect, the hardwiring of the SGPIO transmission side system may be designed based on the design on the SGPIO target side system. Such customization of the SGPIO transmission-side system hardwiring may tend to complicate design and/or increase the cost of providing the SGPIO transmission side system. Further, this may tend to promote non-optimal hardwiring on the SGPIO transmission side system, such as, for example, signal crossings that may degrade signal integrity. Still further, since the hardwiring of the SGPIO target side may vary, in some cases multiple different SGPIO transmission side system designs may be used.

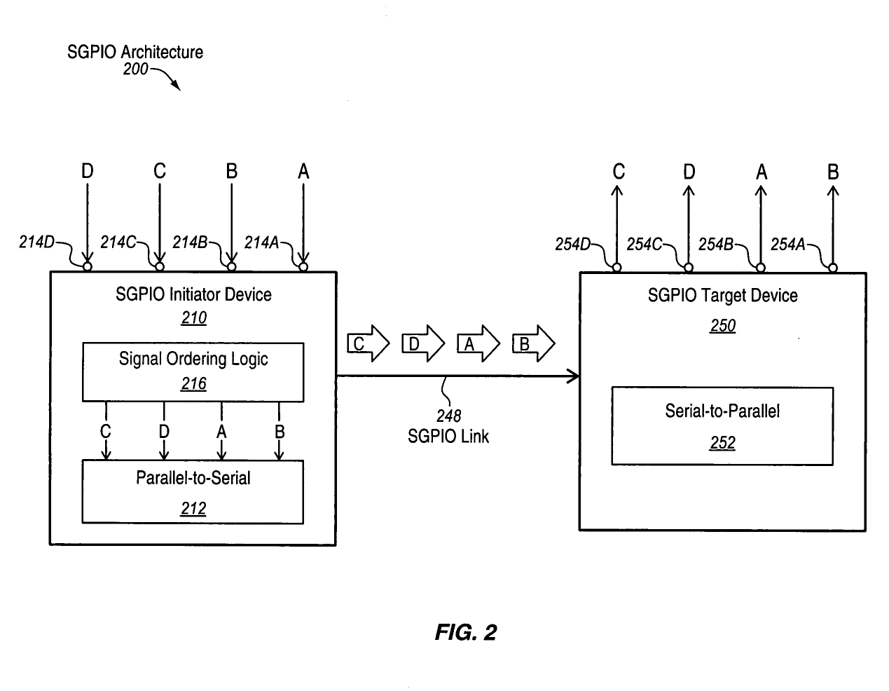

FIG. 2 is a block diagram of an SGPIO architecture 200 including an SGPIO initiator device 210 that has signal. ordering logic 216, according to one or more embodiments of the invention. The signal ordering logic may determine an order in which parallel input signals are provided in a corresponding serial stream.

The SGPIO architecture includes the aforementioned SGPIO initiator device, an SGPIO target device 250, and an SGPIO link 248 coupling the SGPIO initiator and target devices. The SGPIO initiator device includes the aforementioned signal ordering logic, parallel-to-serial conversion logic 212, and first 214A, second 214B, third 214C, and fourth 214D terminals. The SGPIO target device includes serial-to-parallel conversion logic 252, and first 254A, second 254B, third 254C, and fourth 254D terminals.

The correspondingly named components shown in FIGS. 1 and 2 may optionally have common characteristics. To avoid obscuring the following description, the discussion below will primarily focus on the different and/or additional characteristics of the SGPIO architecture shown in FIG. 2.

The SGPIO initiator device may receive a plurality of parallel input signals. For example, as shown in the illustrated embodiment, the SGPIO initiator device may receive the parallel input signals A, B, C, and D. In particular, A may be received on the first terminal 214A, B may be received on a second terminal 214B, C may be received on a third terminal 214C, and D may be received on a fourth terminal 214D.

The signal ordering logic may be coupled with, or otherwise in communication with, the terminals. The parallel input signals may be provided to the signal ordering logic. Information indicating which terminals the respective parallel input signals were received upon may also be provided to the signal ordering logic.

The signal ordering logic may determine an order in which the parallel input signals are to be provided in a serialized stream of signals, according to one or more embodiments of the invention. The serialized stream may be transmitted or otherwise provided over the bus or other interconnect. For example, in the illustrated embodiment, the signal ordering logic may determine that the signal B received on the second terminal is to be chronologically first in the serial stream, and that the signal A received on the first terminal is to be chronologically second in the serial stream. Continuing on with this example, the signal ordering logic may determine that the signal D received on the fourth terminal is to be chronologically third in the serial stream, and that the signal C received on the third terminal is to be chronologically fourth in the serial stream. This is just one illustrative example. The scope of the invention is not limited to just this particular example.

Notice that the order or sequence of the serialized signals need not be based solely on which terminals the corresponding parallel input signals were received upon at the SGPIO initiator device. Rather, the order or sequence of the serialized signals may be based, at least in part, on ordering information from the signal ordering logic. The ordering information from the signal ordering logic may be used to establish the relation between the terminals and the order or sequence.

In one or more embodiments of the invention, the signal ordering logic may determine the order of the serialized signals in order to improve design and/or signal routing within a SGPIO transmission-side system, such as, for example, an adapter and/or circuit board having an SGPIO initiator device. In one or more embodiments of the invention, the signal ordering logic may determine the order of the serialized signals in order to improve routing of interconnects on a circuit board. In one or more embodiments of the invention, the signal ordering logic may determine the order of the serialized signals in order to prevent, or at least suppress or lessen, crossing of interconnects and/or signals on a circuit board to which the parallel-to-serial conversion logic may be coupled.

In one or more embodiments of the invention, the signal ordering logic may include software, such as, for example, a routine or other set of instructions stored on a machine-readable and/or machine-accessible medium. Alternatively, in one or more embodiments of the invention, the signal ordering logic may include hardware, such as, for example, a portion of an integrated circuit or other circuit. As yet another option, in one or more embodiments of the invention, the signal ordering logic may optionally include a combination of software and hardware.

In one or more embodiments of the invention, the signal ordering logic may be programmable or otherwise configurable by a user or practitioner. For example, the practitioner may program or configure relationships between which terminals signals are received on and where the signals appear in order in the serial stream. By way of example, a user may program the signal ordering logic with the ordering information prior to use of the SGPIO initiator device. The ability to program the signal ordering logic may increase the flexibility with which the serialized signals are ordered and used within the architecture. The signal ordering logic may optionally be re-programmable, such as, for example, to add further flexibility or adaptability to the SGPIO architecture.

Suitable programmable logic includes, but is not limited to, programmable software logic and programmable hardware logic. Suitable programmable hardware logic includes, but is not limited to, FPGAs (Field Programmable Gate Arrays), CPLDs (Complex Programmable Logic Devices), and other programmable logic devices (PLDs) known in the arts.

According to one or more embodiments of the invention, a user, practitioner, or circuit design application, may determine an order in which parallel input signals received at terminals of an SGPIO initiator device are to be transmitted in a serial stream. The user, practitioner, or circuit design application may then program signal ordering logic as disclosed herein with the determined order. In one or more embodiments the order may be determined based, at least in part, on information regarding SGPIO target-side systems, such as, for example, SGPIO signal routings within a storage disk array in which an SGPIO target device may be employed. In one or more embodiments of the invention, the order may be determined based, at least in part, on preventing, or at least suppressing, the crossings of interconnects and/or signals on a circuit board having the SGPIO initiator device coupled thereto.

Referring again to FIG. 2, the signal ordering logic may be coupled with, or otherwise in communication with, the parallel-to-serial conversion logic. The ordered or reordered parallel signals may be provided to the parallel-to-serial conversion logic, which may generate a corresponding serial stream based on the parallel input signals, as previously described. The SGPIO initiator device may provide the serial stream to the SGPIO target device via the interconnect. For example, as shown, the SGPIO initiator device may provide a serialized stream in which a serialized signal B may be provided first, a serialized signal A may be provided second, a serialized signal D may be provided third, and a serialized signal C may be provided fourth.

The SGPIO target device may receive the serial stream. For example, as shown, the SGPIO target device may receive B first, A second, D third, C fourth. The SGPIO target device includes the serial-to-parallel conversion logic to generate a plurality of parallel output signals based, at least in part, on the serial stream.

One potential advantage of the signal ordering logic disclosed herein may be the use of an off-the-shelf circuit board in a SGPIO transmission-side system, such as, for example, an adapter having the off-the-shelf circuit board and the SGPIO initiator device coupled thereto. In one or more embodiments of the invention, the off-the shelf circuit board need not be customized based on design of SGPIO target-side systems or signal routings therein, since the signal ordering logic disclosed herein may account for discrepancies. The off-the-shelf circuit board may be used as-is and interoperate with existing different SGPIO target-side systems without adaptation or customization based on the detailed internal knowledge of the SGPIO target-side systems. This may offer a cost savings in that the interconnect routings or other aspects of the hardware design of the SGPIO initiator-side systems, such as, for example, adapters and circuit boards thereof, need not be customized for particular use environments.

SGPIO architectures may be used in conjunction with storage architectures, such as, Serial Attached Small Computer System Interface (SAS) and Serial Advanced Technology Attachment (SATA), as well as in other environments. By way of example, the SGPIO architecture may be used to convey light emitting diode (LED) control signals to storage devices. The storage devices may use the LED control signals to control LEDs that may provide user feedback regarding the status or state of the storage devices.

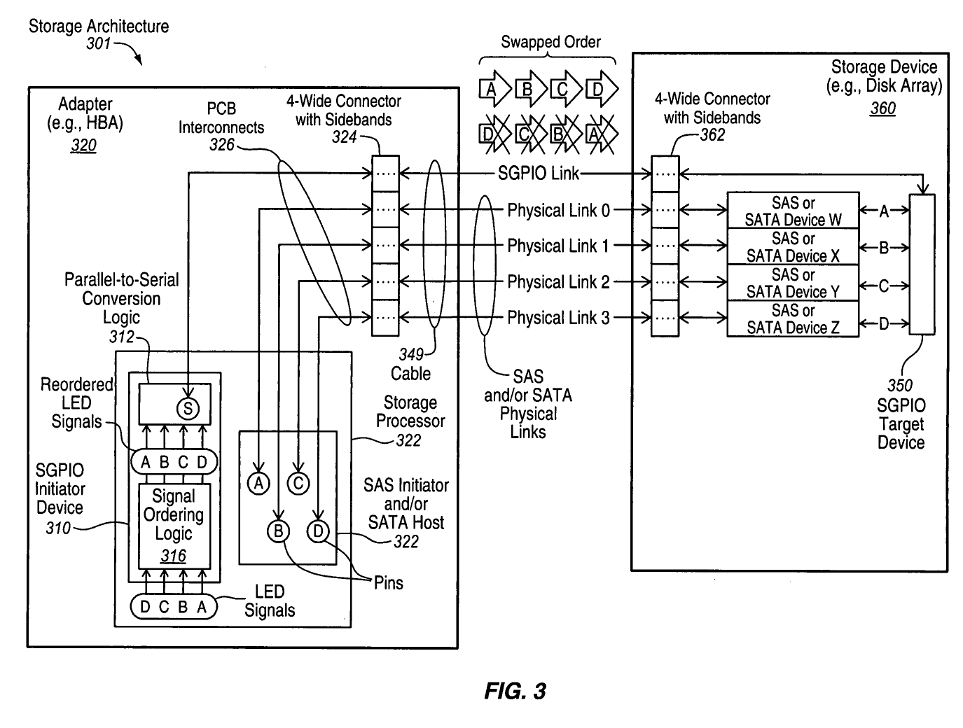

FIG. 3 is a block diagram showing how an SGPIO initiator device 310 that has signal ordering logic 316 may be implemented in a storage architecture 301, according to one or more embodiments of the invention.

The storage architecture includes an adapter 320, such as, for example, a host bus adapter (HBA), a storage device 360, such as, for example, a storage disk array or a SAS and/or SATA disk cabinet, and a cable 349. The adapter may be coupled with, or otherwise in communication with, the storage device, through the cable.

The adapter includes a printed circuit board (PCB) substrate, which is not shown, a storage processor 322, a connector 324, such as, for example, a four-wide connector with sidebands, and interconnects 326 on the PCB. The storage processor may be coupled with, or otherwise in communication with, the connector, through interconnects on the PCB substrate.

The storage processor includes a SAS (Serial Attached SCSI) initiator and/or SATA (Serial Advanced Technology Attachment) host 328, and the aforementioned SGPIO initiator device. The SGPIO initiator device includes the aforementioned signal ordering logic and parallel-to-serial conversion logic.

The SAS initiator and/or SATA host includes a plurality of terminals including a first terminal (A), a second terminal (B), a third terminal (C), and a fourth terminal (D). The parallel-to-serial conversion logic includes an output terminal (S). Each of the terminals are coupled with, or otherwise in communication with, respective ports or other portions of the connector, through the interconnects on the PCB.

The storage device, such as, for example, the storage disk array, includes a connector 362, a plurality of storage devices, and an SGPIO target device 350. As shown, the connector may include a four-wide connector with sidebands, although the scope of the invention is not limited in this respect. The plurality of storage devices include a first SAS or SATA device (W), a second SAS or SATA device (X), a third SAS or SATA device (Y), and a fourth SAS or SATA device (Z). Suitable SAS or SATA devices include, but are not limited to, SAS drives, SATA drives, and SATA port multipliers.

Each of the storage devices may be coupled with, or otherwise in communication with, respective ports or other portions of the connector of the storage device. The SGPIO target device may be likewise coupled with, or otherwise in communication with, a port or other portion of the connector of the storage device. The SGPIO target device may also be coupled with, or otherwise in communication with, each of the storage devices to provide a parallel output signal to each of the storage devices.

The cable may be coupled with, or otherwise in communication with, the connector of the adapter. The cable may also be coupled with, or otherwise in communication with, the connector of the storage device. The illustrated cable includes an SGPIO link and a plurality of SAS and/or SATA physical links. The plurality of SAS and/or SATA physical links includes a SAS and/or SATA physical link 0, a SAS and/or SATA physical link 1, a SAS and/or SATA physical link 2, and a SAS and/or SATA physical link 3. The SGPIO link couples the terminal (S) of the parallel to serial conversion logic with the SGPIO target device via the two intervening ports or other portions of the connectors.

Notice that terminal A corresponds to device W, terminal B corresponds to device X, terminal C corresponds to device Y, and terminal D corresponds to device Z. In particular, the physical link 0 couples the terminal (A) of the SAS initiator and/or SATA host with the SAS or SATA device W via the two intervening ports or other portions of the connectors. Likewise, the physical link 1 couples the terminal (B) of the SAS initiator and/or SATA host with the SAS or SATA device X via the two intervening ports or other portions of the connectors. Similarly, the physical link 2 couples the terminal (C) of the SAS initiator and/or SATA host with the SAS or SATA device Y via the two intervening ports or other portions of the connectors. In similar fashion, the physical link 3 couples the terminal (D) of the SAS initiator and/or SATA host with the SAS or SATA device Z via the two intervening ports or other portions of the connectors.

In one or more embodiments of the invention, the SGPIO initiator device may communicate light emitting diode (LED) control signals that may be used by the storage device to control LEDs that may provide status information regarding the corresponding SAS or SATA device to a user. Representatively, the LED control signals may convey that an LED is to be on, is to be off, is to blink, or is to be mostly on but off during drive activity. These are just a few examples. The scope of the invention is not limited to just these examples.

As shown, the SGPIO initiator device may receive LED control signals on pins or other terminals. In particular, the SGPIO initiator device may receive LED control signal A on a first terminal, LED control signal B on a second terminal, LED control signal C on a third terminal, and LED control signal D on a fourth terminal.

In this example, LED control signal A corresponds to terminal A, LED control signal B corresponds to terminal B, LED control signal C corresponds to terminal C, and LED control signal D corresponds to terminal D. The LED control signals may be provided to the signal ordering logic. In accordance with one or more embodiments of the invention, the signal ordering logic may determine an order in which the parallel input LED control signals are to be provided in a serialized stream of LED control signals so that when de-serialized on the SGPIO reception side of the architecture the signals are assigned and routed to the proper corresponding SAS or SATA devices with which the pins or terminals of the SAS initiator and/or SATA host are coupled for communication. In one or more embodiments of the invention, the signal ordering logic may include a programmable switch, either hardware or software, that may allow the LED control signals to be provided in a predetermined order that is based on the receive side.

The reordered LED control signals may then be provided to the parallel-to-serial conversion logic. The parallel-to-serial conversion logic may generate a serial LED control signal based on the parallel LED control signals. The serial LED control signal may be provided to the storage device via the cable. As shown, the LED control signals may be provided in the chronological order first LED control signal D, then LED control signal C, then LED control signal B, and finally LED control signal A, as opposed to the reverse chronological order which may otherwise result without the signal ordering logic depending upon the particular design of the adapter.

The serialized LED control signals may be received at the port or other portion of the connector of the storage device and may be provided to the SGPIO target device. The SGPIO target device may generate a plurality of parallel LED control signals based on the serialized LED control signals. There may be a predetermined assignment and routing of the signals of the serial stream to the plurality of storage devices.

In particular, as shown in the illustrated embodiment, the SGPIO target device may assign and route the first chronologically received serialized LED control signal to the SAS or SATA device Z, and may assign and route the second chronologically received serialized LED control signal to the SAS or SATA device Y. Continuing, the SGPIO target device may assign and route the third chronologically received serialized LED control signal to the SAS or SATA device X, and may assign and route the fourth chronologically received serialized LED control signal to the SAS or SATA device W.

As previously discussed, such correspondence may be hardwired or otherwise deterministically set within the design of the storage device. As shown, the storage device may be designed so that the assignments and routings of the parallel output signals from the SGPIO target to the SAS or SATA devices are clean and there are relatively few, if any, interconnect crossings. Interconnect crossings may tend to adversely reduce signal integrity.

As shown, as a result of ordering the signals with the signal ordering logic, LED control signal A may be assigned and routed to SAS or SATA device W, which may be proper since terminal A corresponds to SAS or SATA device W. Likewise, LED control signal B may be assigned and routed to SAS or SATA device X, which may be proper since terminal B corresponds to device X. Similarly, LED control signal C may be assigned and routed to SAS or SATA device Y, which may be proper since terminal C corresponds to device Y. In similar fashion, LED control signal D may be assigned and routed to SAS or SATA device Z, which may be proper since terminal D corresponds to device Z. Hypothetically, without the signal ordering logic, based on fixed system design, the signals may be provided in the improper reverse order in which LED control signal A was erroneously provided to SAS or SATA device Z, which was connected with terminal D, rather than terminal A.

Accordingly, assuming that the storage disk array or other storage device has already been designed, and that internal assignment and routing of the serialized stream to different storage devices has already been deterministically set, the signal ordering logic as disclosed herein may allow use of an off-the-shelf circuit board having predetermined or preexisting and already designed interconnect routings from the terminals to the ports or other portions of the connector. There may be no need to adapt, customize, or redesign the circuit board or the interconnect routings thereof based on the design of the storage disk array. Rather, the signal ordering logic may change the order of the signals in the serial stream to accommodate for the fixed design of the off-the-shelf circuit board. In one or more embodiments of the invention, the signal ordering logic may be programmed once before use by a practitioner taking into consideration the assignment and routing within the storage disk array using, for example, specifications from the vendor. Programming the order of the signals in the serial stream may be much less time consuming than redesigning the circuit board. Additionally, as shown in the illustrated embodiment, the off-the-shelf circuit board may be designed to have clean interconnect routings in which few if any of the interconnects cross. This may help to maintain signal integrity.

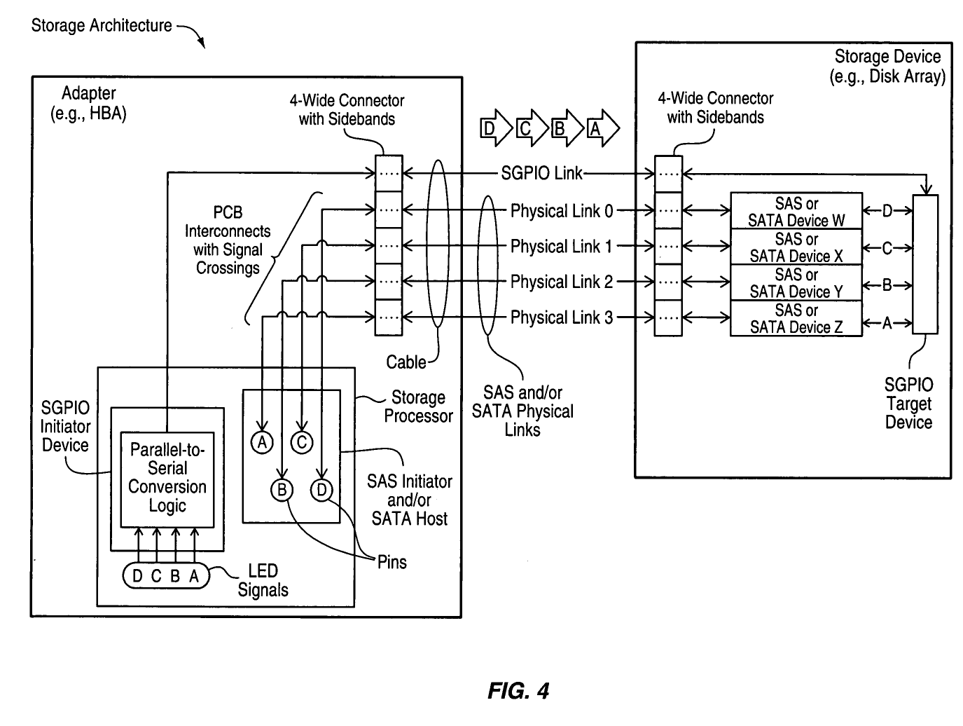

Without such signal ordering logic as disclosed herein, the printed circuit board and the interconnect routings thereon would sometimes be redesigned or customized to account for the fixed design of the storage device. A representative way in which the adapter may be redesigned is shown in FIG. 4. Such customization may tend to complicate design of the SGPIO architecture and/or increase the cost of providing the SGPIO architecture. Additionally, as shown, interconnect routings on the printed circuit board may tend to cross, which may tend to degrade signal integrity.

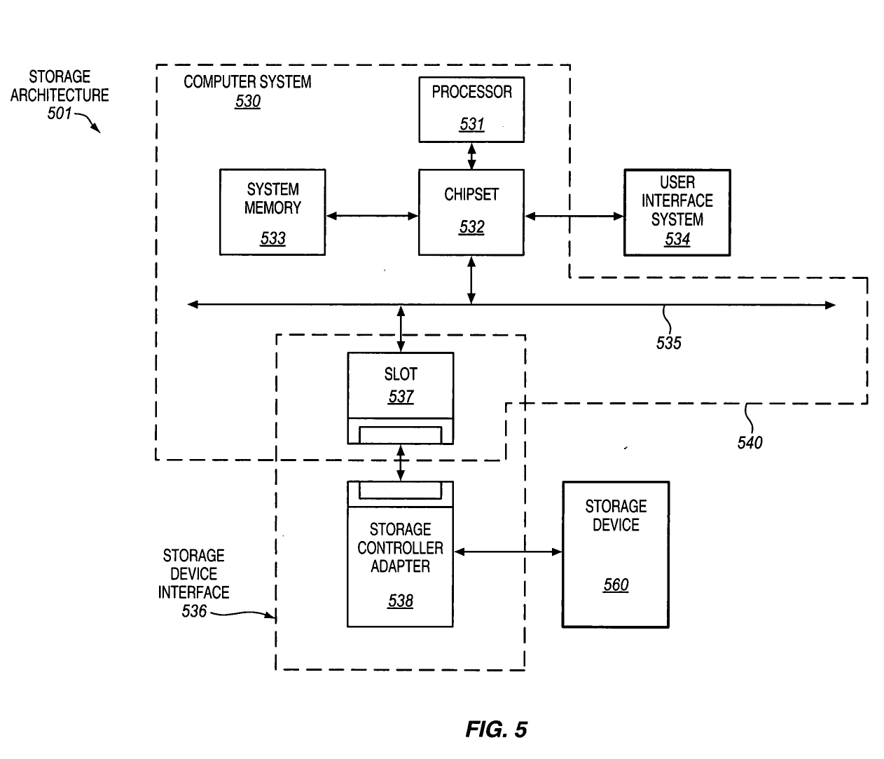

FIG. 5 is a block diagram showing a storage architecture 501 suitable for implementing one or more embodiments of the invention. The storage architecture includes a computer system 530, a user interface system 534, a storage devices 560, and a storage controller adapter 538 to allow the computer system to interface with the storage device.

As used herein, a “computer system” may include an apparatus having hardware and/or software to process data. The computer system may include, but is not limited to, a portable, laptop, desktop, server, or mainframe computer, to name just a few examples. The computer system represents one possible computer system for implementing one or more embodiments of the invention, however other computer systems and variations of the computer system are also possible.

The computer system includes a processor 531 to process information. In one or more embodiments, the processor may include a processor in the Pentium® family of processors, such as, for example, a Pentium® 4 processor. The Pentium® family of processors are commercially available from Intel Corporation, of Santa Clara, Calif. Alternatively, other processors may optionally be used. As one example, a processor having multiple processing cores may be used. As another example, a processor manufactured and/or commercially available from a source other than Intel Corporation may optionally be used. Further, in one or more embodiments, the computer system may include multiple processors.

The processor may be coupled with a chipset 532 by an interface. As shown, a system memory 533, the user interface system, and one or more input/output (I/O) buses or other interconnects 535, may also each be coupled with, or otherwise in communication with the chipset by respective interfaces.

In one or more embodiments of the invention, the chipset may include one or more integrated circuits or other microelectronic devices, such as, for example, those that are commercially available from Intel Corporation. However, other microelectronic devices may also, or alternatively, be used.

In one or more embodiments of the invention, the chipset may include a first bridge/hub (not shown), such as, for example, a memory control bridge/hub available from Intel Corporation, and a second bridge/hub (not shown), such as, for example, an input/output (I/O) bridge/hub available from Intel Corporation. In one or more other embodiments, at least a portion of the memory control bride/hub, such as, for example, the memory controller, may be in the same chip as the processor. The first bridge/hub may be coupled with the second bridge/hub by a hub interface. However, the scope of the invention is not limited to using such chipsets.

The system memory may be coupled with, or in communication with, the memory control bridge/hub, or otherwise in communication with the chipset. In one or more embodiments of the invention, the system memory may include a main memory, such as, for example, a random access memory (RAM) or other dynamic storage device, to store information including instructions to be executed by the processor. Different types of RAM memory that are included in some, but not all computer systems, include, but are not limited to, static-RAM (SRAM) and dynamic-RAM (DRAM). Other types of RAM that are not necessarily dynamic or need to be refreshed may also optionally be used.

Additionally, in one or more embodiments of the invention, the system memory may include a read only memory (ROM) to store static information and instructions for the processor, such as, for example, the basic input-output system (BIOS). Different types of memory that are included in some, but not all, computer systems include Flash memory, programmable ROM (PROM), erasable-and-programmable ROM (EPROM), and electrically-erasable-and-programmable ROM (EEPROM).

The user interface system may representatively include devices, such as, for example, a display device, a keyboard, a cursor control device, and combinations thereof, although the scope of the invention is not limited in this respect. For example, some computer systems, such as servers, may optionally employ simplified user interface systems.

The one or more I/O interconnects and the user interface system may be coupled with, or otherwise in communication with, the I/O bridge/hub, or otherwise in communication with the chipset. Suitable I/O interconnects include, but are not limited to, peripheral component interconnect (PCI) family buses, accelerated graphics port (AGP) buses, universal serial bus (USB) buses, low pin count (LPC) buses, other kinds of I/O buses, or combinations thereof. In one particular embodiment of the invention, the one or more I/O interconnects may include a PCI, PCIX (PCI extended), and/or PCI-Express (PCI-E) bus. The chipset and the I/O bridge/hub may accordingly support standard I/O operations on one or more of such I/O interconnects. As shown in the illustrated embodiment, a storage device interface 536 may be coupled with the one or more I/O interconnects. The one or more interconnects may be used to communicate information among components.

The illustrated storage device interface includes a slot or port 537 and the storage controller adapter 538. The adapter may include an SGPIO initiator having signal ordering logic in accordance with one or more embodiments of the invention. The signal ordering logic may include hardware, software, or a combination of hardware and software. The software may either be executed by a processor on the adapter or by the processor of the computer system.

The adapter may optionally have the form of a card, although this is not required. The slot may be coupled with, or otherwise in communication with, the one or more I/O interconnects. The slot and the adapter may be constructed to permit the adapter to be inserted into the slot and electrically coupled with the slot to allow the adapter to be coupled with, or otherwise in communication with, the one or more I/O interconnects. For example, an interface of the slot may include a bus or other interconnect connector that may be electrically and mechanically mated with a mating bus or other interconnect connector that may be included in an expansion slot or interface of the adapter. When the adapter is properly inserted into the slot, the mating connectors may become mechanically and/or electrically coupled with each other. When the connectors are so coupled with each other, the adapter may become electrically coupled with the one or more I/O interconnects and may exchange data with components of the computer system.

The storage device may be coupled with the storage device interface, for example the adapter, via a link. Suitable storage devices include, but are not limited to, hard disks, pluralities of hard disks, storage disk arrays, Just a Bunch Of Disks (JBOD), other sets of hard disks and ones, pluralities, and arrays of other types of storage devices besides hard disks, such as, for example, CD-ROM devices, tape drives, Zip drives, SuperDisk drives, and the like. Devices besides storage devices may also optionally be employed. The scope of the invention is not limited to just storage devices.

Now, as shown in the illustrated embodiment, the processor, system memory, chipset, one or more I/O interconnects, and slot may optionally be included on or otherwise connected to a main circuit board 540, such as, for example, a motherboard or backplane. The motherboard and the components connected thereto may be housed within a primary chassis or housing of the computer system. Components of the user interface system and the set of storage devices may, in one or more embodiments, be outside of the chassis or housing. The slot may represent an opening in the chassis or housing into which the adapter may be inserted.

However, this particular configuration or arrangement is not required. Numerous alternate configurations are also contemplated. For example, in various alternate embodiments of the invention, portions of the adapter may be integrated onto the motherboard or backplane and provided within the chassis or housing. Many additional modifications are also contemplated. Representatively, an SGPIO initiator device having signal ordering logic as disclosed herein may be integrated or consolidated with the motherboard and/or the chipset.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

Various operations and methods have been described. Some of the methods have been described in a basic form, but operations may optionally be added to and/or removed from the methods. The operations of the methods may also optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, one or more processors, adapters, HBAs, computer systems, and a wide variety of other devices with one or more processors, to name just a few examples.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

A medium may also optionally include an electrical, optical, acoustical, radiofrequency, or other form of propagated signal, such as carrier waves, infrared signals, digital signals, for example. One or more embodiments of the invention may be downloaded as a computer program product, wherein the program may be transferred from one machine to another machine by way of data signals embodied in a carrier wave or other propagation signal or medium via a communication link (for example a modem or network connection).

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Such recitations do not necessarily refer to the same embodiment. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A device comprising:
terminals of an Serial General Purpose Input Output (SGPIO) initiator device, the terminals to receive parallel input signals;
parallel-to-serial conversion logic to convert the parallel input signals to a serial stream;
signal ordering logic in communication with the terminals and in communication with the parallel-to-serial conversion logic, the signal ordering logic to determine an order in which the parallel input signals are provided in the serial stream where the order is based on an SGPIO target device.

2. The device of claim 1, wherein the signal ordering logic comprises programmable signal ordering logic.

3. The device of claim 1, wherein the signal ordering logic is to determine the order to improve routing of interconnects on a circuit board.

4. The device of claim 1, wherein the signal ordering logic is to determine the order to prevent crossing of interconnects on a circuit board to which the parallel-to-serial conversion logic is coupled.

5. The device of claim 1, further comprising an off-the-shelf circuit board coupled with the parallel-to-serial conversion logic, wherein the off-the shelf circuit board is not customized based on interconnect routing within a device having an SGPIO target.

6. The device of claim 1, wherein the parallel input signals comprise light emitting diode control signals.

7. The device of claim 1, wherein the signal ordering logic comprises instructions stored on a machine-readable medium.

8. The device of claim 1, wherein the signal ordering logic comprises a circuit.

9. An article of manufacture comprising:
a machine-accessible medium that provides instructions that when executed result in a machine performing operations including,
determining an order in which parallel input signals received at an Serial General Purpose Input Output (SGPIO) initiator are to be provided in a serial stream;
providing the order to parallel-to-serial conversion logic.

10. The article of manufacture of claim 9, wherein the instructions that when executed result in the machine performing said determining further comprise instructions that when executed result in the machine performing operations comprising,
informing the parallel-to-serial conversion logic that a parallel input signal was received on a terminal which the parallel input signal was not actually received on.

11. The article of manufacture of claim 9, wherein the instructions that when executed result in the machine performing said determining the order further comprise instructions that when executed result in the machine performing operations comprising,
determining the order to improve interconnect routing on a circuit board.

12. The article of manufacture of claim 9, wherein the instructions that when executed result in the machine performing said determining the order further comprise instructions that when executed result in the machine performing operations comprising,
determining the order to suppress crossing of interconnects on a circuit board.

13. The article of manufacture of claim 9, wherein the machine-accessible medium further provides instructions that when executed result in the machine performing operations including,
allowing the order to be reprogrammed.

14. A method comprising:
determining an order in which parallel input signals received at terminals of an Serial General Purpose Input Output (SGPIO) initiator are to be transmitted in a serial stream, wherein said determining is based, at least in part, on interconnect routing on a circuit board with which the SGPIO initiator is coupled; and
programming signal ordering logic with the determined order.

15. The method of claim 14, wherein said determining is based, at least in part, on prevent interconnects from crossing.

16. The method of claim 14, wherein said determining is based, at least in part, on interconnect routing within a device having an SGPIO target.

17. A system comprising:
a computer system comprising a dynamic random access memory (DRAM); and
an adapter in communication with the computer system, the adapter including an Serial General Purpose Input Output (SGPIO) initiator device, the SGPIO initiator device including:
terminals to receive parallel input signals; parallel-to-serial logic to generate a serial stream based on the parallel input signals;
signal ordering logic in communication with the terminals and in communication with the parallel-to-serial logic, the signal ordering logic to determine an order in which the parallel input signals are provided in the serial stream.

18. The system of claim 17, wherein the signal ordering logic comprises programmable logic.

19. The system of claim 17, wherein the signal ordering logic is to determine the order to improve routing of interconnects on a circuit board.

20. The system of claim 17, wherein the signal ordering logic is to determine the order to prevent crossing of interconnects on a circuit board to which the parallel-to-serial conversion logic is coupled.
